(19) United States
(12) Patent Application Publication
(10) Pub. No.: US 2005/0194106 A1
(43) Pub. Date: Sep. 8, 2005

(54) Overhead door and fence cover

(76) Inventor: Rod Scales, Dallas, TX (US)

Correspondence Address: SLATER & MATSIL, L.L.P., 17950 PRESTON RD, SUITE 1000, DALLAS, TX, 75252-5793, US

(21) Appl. No.: 10/794,505

(22) Filed: Mar. 5, 2004

(51) Int. Cl. E05D 15/16

(52) U.S. Cl. 160/201

(57) ABSTRACT

An overhead door, an overhead door cover, a method of covering an overhead door, and fence covers and methods. A digital photographic image is divided into a plurality of portions, and the portions of the image are enlarged and recreated onto panels of an overhead door or onto a medium, which medium is used as an overhead door cover panel. When reassembled on an overhead door or other substantially flat object, the image gives the overhead door or flat object the appearance of a realistic object or scene, such as a wooden door or a nature scene.

### TECHNICAL FIELD

The present invention relates generally to the fabrication of overhead doors, decorative covers for overhead doors and fences, and methods of covering overhead doors and fences.

### BACKGROUND

Overhead doors are doors that slide open and closed on channels that are usually hung by the ceilings of the rooms to which the overhead door provides an entry. Overhead doors are commonly used as garage doors, and they may comprise single car garage doors or double car garage doors, as examples. Overhead doors are also used in a variety of other dwellings, such as storage units, warehouses, store fronts, and restaurants, as examples.

Older overhead garage doors manufactured 50 or so years ago comprised a single flat door. Newer designs comprise a plurality of horizontal panels, as shown in FIG. 1. The overhead door 100 shown is adapted to fit and cover the opening or doorway 104 within a dwelling 102 such as a home. The overhead door 100 includes a plurality of horizontally-extending panels 106a, 106b, 106c, and 106d, which panels 106a, 106b, 106c, and 106d are coupled to an adjacent panel by hinges 108. The overhead door 100 includes wheels 110 at the exterior edge thereof in several locations, typically located in the same general position horizontally as the hinges 108. The wheels 110 are adapted to slide within the overhead tracks 112 which extend into the room of the dwelling 102 so that the overhead door 100 may be fully retracted within the room of the dwelling 102. The overhead door 100 system may include a motor 114 which is generally disposed above the door 100 when in the retracted position. Initiating the opening and closing of the overhead door 100 is generally by remote control or may alternatively be initiated by a button located inside the room of the dwelling 102, not shown. Alternatively, the overhead door 100 system may not include a motor and may be operable using a handle located on the inside, shown at 120, outside (not shown), or both, of the overhead door 100.

The overhead door 100 may include one or more windows 116 which are generally located in an upper panel 106d of the overhead door 100. The overhead door 100 may also include three-dimensional patterns 118 to add a more pleasing aesthetic look to the door 100. However, windows 116 and three-dimensional patterns 118 are optional, and some overhead door 100 devices do not include them. The overhead door 100 may include a locking device 122 and other features, not shown. More modem designs of overhead doors 100 tend to not have a handle 120.

A problem with the prior art overhead door 100 design shown is that it is not aesthetically very pleasing. There is a trend in the building and remodeling industry towards the use of wooden overlays. The wooden overlays typically comprise panels of real wood, and are often quite heavy. Often, the wooden overhead doors are stained with a wood stain finish. These overlaid doors are quite expensive, and are subject to fading, splitting, pieces being shaken loose, and deterioration due to exposure to sunlight and to the elements.

What is needed in the art is a structure and method for improving the aesthetic appearance of overhead doors, while avoiding high costs and without adding a large amount of weight to the overhead door system.

### SUMMARY OF THE INVENTION

These and other problems are generally solved or circumvented, and technical advantages are generally achieved, by preferred embodiments of the present invention which comprise an overhead door design, a cover for an overhead door, and a method of covering an overhead door. A realistic digital photographic image is reproduced on the surface of an overhead door, giving it the appearance of a realistic object such as a wooden overhead door, or a nature scene. The digital photographic image is divided into portions, with each portion corresponding to a panel of the overhead door. The digital photographic image portions are either printed directly onto overhead door panels prior to the delivery of the overhead door, or alternatively, the digital photographic image portions may be printed on a set of panels that are subsequently attached to the panels of an overhead door that has been previously installed on a dwelling. The panels having the digital photographic image portions disposed thereon may be used to cover a fence or other vertical substantially flat surfaces.

In accordance with a preferred embodiment of the present invention, an overhead door includes a plurality of first horizontally-extending panels, each first horizontally-extending panel including a portion of a digital photographic image disposed thereon, and a plurality of hinges coupling together the first horizontally-extending panels, wherein the digital photographic image portions disposed on the plurality of first horizontally-extending panels gives the overhead door the appearance of a realistic object or scene.

In accordance with another preferred embodiment of the present invention, a cover for an overhead door includes at least one first horizontally-extending panel, the cover comprising a plurality of second panels, each of the second panels comprising a medium and having a portion of a digital photographic image disposed thereon, wherein each second panel is attached to the at least one first horizontally-extending panel, and wherein the digital photographic image portions disposed on the plurality of second panels gives the overhead door the appearance of a realistic object or scene.

In accordance with yet another preferred embodiment of the present invention, a method of covering an overhead door, the overhead door comprising at least one horizontally-extending panel, includes providing a digital photograph of a scene or object, the digital photograph comprising digital information of an image of the scene or object; and enlarging and recreating portions of the digital photograph onto the at least one horizontally-extending panel of the overhead door, wherein recreating the portions of the digital photograph on the at least one horizontally-extending panel of the overhead door gives the overhead door the appearance of a realistic object or scene.

In accordance with another preferred embodiment of the present invention, a cover for a fence includes a plurality of horizontally-extending panels, each of the horizontally-extending panels comprising a medium and having a portion of a digital photographic image disposed thereon, wherein each horizontally-extending panel is attachable to the fence, and wherein the digital photographic image disposed on the plurality of horizontally-extending panels gives the fence the appearance of a realistic nature scene.

In accordance with yet another preferred embodiment of the present invention, a method of covering a fence includes providing a digital photograph of a nature scene, the digital photograph comprising digital information of an image of the nature scene. The digital photograph is divided into sections, the sections being oriented horizontally. A plurality of horizontally-extending panels is provided, the horizontally-extending panels comprising a medium, and each section of the digital photograph is enlarged and recreated onto the plurality of horizontally-extending panels; and the plurality of horizontally-extending panels are attached to the fence, wherein the plurality of horizontally-extending panels gives the fence the appearance of a realistic nature scene.

Advantages of embodiments of the present invention include providing a low-cost, aesthetically pleasing cover for an overhead door or a fence. The decorative cover design may be printed directly onto the panels of an overhead door, or alternatively, the decorative cover digital photographic image may be disposed on a medium which is then attached to each panel of the overhead door. Adjacent panels of the overhead door cover may overlap, preventing water and debris from entering into the dwelling, in one embodiment. The panels of the cover may comprise a durable or opaque material so that windows of an existing overhead door are covered, thereby increasing security. The decorative cover gives the appearance of a realistic wooden door at a fraction of the cost of an actual wooden overhead door. The panels of the overhead door cover are easily installed onto an existing overhead door.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a prior art overhead door, comprising four panels hinged together, with windows disposed in the top panel;

FIG. 2 shows an embodiment of the present invention, wherein an overhead door is covered with portions of a digital photographic image to create an appearance of a realistic object such as a wooden door;

FIG. 3 shows a perspective view of a panel of a cover in accordance with an embodiment of the present invention being attached to a panel of a prior art overhead door such as the one shown in FIG. 1;

FIG. 4a shows an embodiment of the present invention, wherein the overhead door comprises a single panel medium;

FIG. 4b shows an embodiment of the present invention wherein the cover medium comprises more than one layer;

FIG. 4c shows an alternative embodiment of the present invention, wherein the digital photographic image is recreated directly onto the surface of the overhead door panel;

FIG. 5 shows a cross-sectional view of an overhead door having an overhead door cover disposed thereon in accordance with an embodiment of the present invention;

FIG. 6 shows a cross-sectional view of the door shown in FIG. 1 in a partially retracted state;

FIG. 7a shows an embodiment of the present invention, wherein a multiple panel cover is applied to a vertical, flat surface such as a fence; and

FIG. 7b shows the fence of FIG. 7a after the cover has been installed, depicting a realistic nature scene.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an overhead door or a fence cover. Embodiments of the present invention may also be applied, however, to other substantially flat surfaces that are manufactured in horizontally-extending panels and attached together, or other vertical substantially flat surfaces.

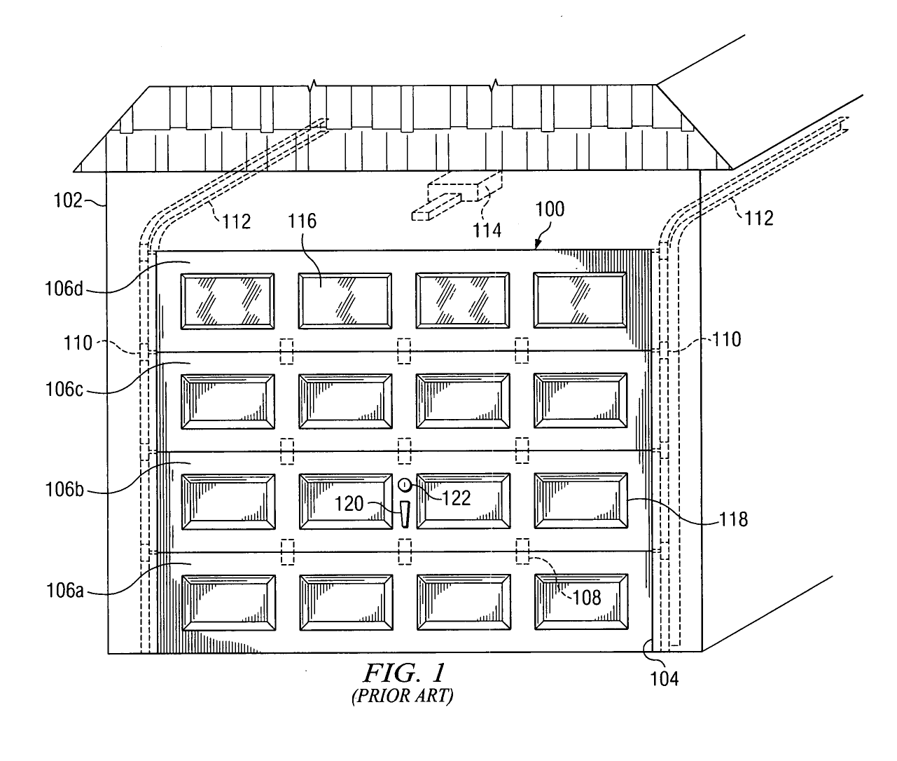

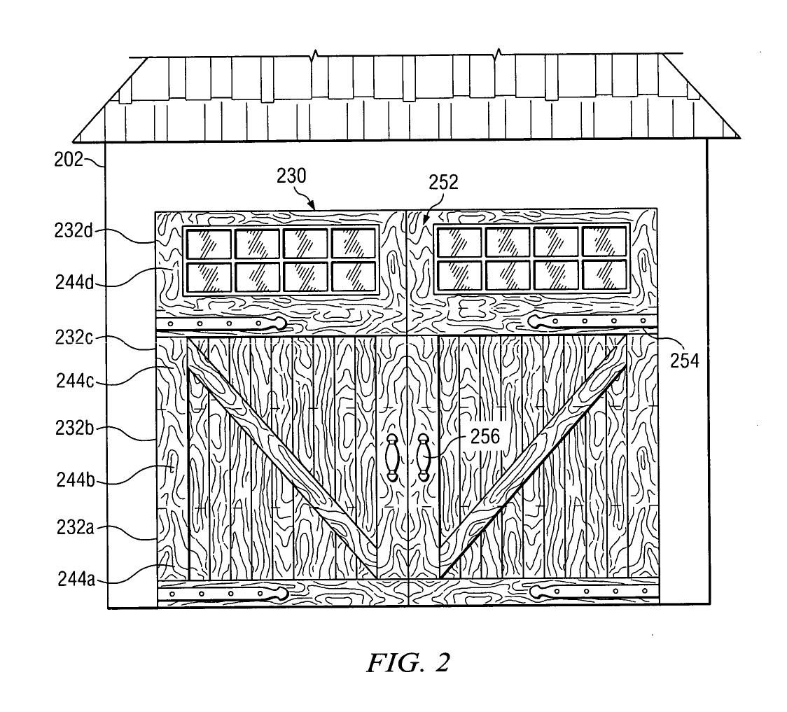

FIG. 2 shows an overhead door having an overhead door cover 230 disposed thereon or attached thereto. First, a digital photographic image 252 is provided. The digital photographic image 252 preferably comprises an image of a wooden door, an old-fashioned-style wooden coach door, a set of wooden doors, a set of old-fashioned-style wooden coach doors, or a nature scene. The image shown in FIG. 2 depicts a set of old-fashioned style wooden coach doors, for example, including an image 252 of a hinge 254 and rustic handles 256. The digital photographic image 252 is divided into portions 244a, 244b, 244c, 244d, with the number of portions 244a, 244b, 244c, 244d being equal to the number of panels 106a through 106d of an overhead door 100 such as the one shown in FIG. 1 that the overhead door cover 230 will be attached to. A common number of panels for a overhead door 100 is typically four, although alternatively, an overhead door 100 may comprise five or more panels.

The portions 244a, 244b, 244c, 244d of the digital photographic image 252 are either printed directly onto an overhead door, e.g., during manufacturing of the overhead door panels, or alternatively, the portions 244a, 244b, 244c, 244d of the digital photographic image 252 are enlarged and recreated on a medium, to be described further herein. When a medium is used to display the digital photographic image 252 portions 244a, 244b, 244c, 244d, the cover 230 comprises a plurality of panels 232a, 232b, 232c, and 232d, with each of the panels 232a through 232d corresponding with a panel 106a, 106b, 106c and 106d, respectively, of the overhead door 100.

Referring again to FIG. 1, if the overhead door 100 includes a door handle 120, preferably the door handle 120 is removed before installing the plurality of panels 232a, 232b, 232c, and 232d shown in FIG. 2. If the overhead door 100 includes a lock 122, the lock 122 is covered by a panel 232b of the overhead garage door cover 230, and the lock 122 is no longer operable from the exterior of the overhead door. In this case, the lock may be operated from the interior of the overhead door, e.g., from the inside of the garage or room that the overhead door provides access to.

FIG. 3 shows a perspective view of a panel 232d being attached to a panel 106d or 106c, of a prior art overhead door 100 such as the overhead door 100 shown in FIG. 1. The overhead door panel 106d preferably comprises a first height h₁ and a first width w₁, as shown. The panel 232d of the overhead door cover 230, shown in FIGS. 2 and 3, preferably comprises a second height h₂ and a second width w₂. The first width w₁ of the overhead door panel 106d/106c is preferably substantially equal to the second width w₂ of the panel 232d of the overhead door cover 230 so that the entire first width w₁ of the overhead door 100 is covered with the portion of the digital photographic image 244d. The overhead door panel 106d/106c may comprise a width w₁ of about 7 or 8 feet for single car garage, or about 14 to 16 feet for a two car garage, as examples, and a height h₁ of about 2 feet, for example.

Also, preferably, the second height h₂ of the overhead door cover panel 232d is substantially equal to the first height h₁ of the overhead door panel 106d/106c, also so that the portion 244d of digital photographic image preferably covers the entire first height h₁ of the overhead door panel 106d. However, in one embodiment of the present invention, the second height h₂ may be greater than the first height h₁ by about ⅛″ to ½″ so that the overhead door cover panel 232d slightly overlaps an adjacent lower overhead door panel 106c or 106b of FIG. 1, for example, to be described further herein. The overhead door cover panel 232d is preferably attached to the overhead door panel 106d using an attachment means 234.

Note that advantageously, if the overhead door panel 106d comprises a broken window 116a, a dent or hole 124, or a three-dimensional design 118, the overhead door cover panel 232d covers these imperfections 116a and 124 and features 118, and provides an improved aesthetic appearance.

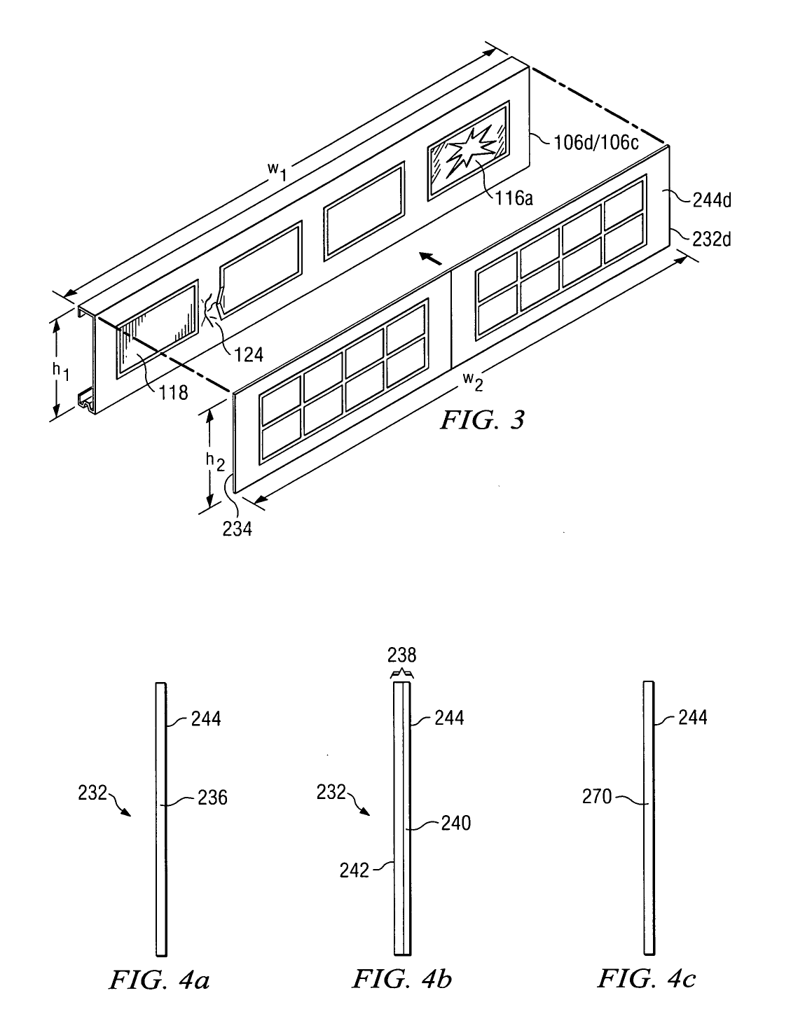

FIGS. 4a, 4b, and 4c show cross-sectional views in accordance with embodiments of the present invention. FIGS. 4a and 4b show embodiments for the panels 232a through 232d (shown generally at 232) that display the portions of the digital photographic image 244a through 244d (shown generally at 244), and FIG. 4c shows an embodiment wherein the portions of the digital photographic image 244 are disposed directly onto panels 270 of an overhead garage door.

FIG. 4a shows an embodiment of the present invention, wherein the medium 236 comprises a single layer having the portion 244 of the digital photographic image displayed thereon. In this embodiment, the medium 236 preferably comprises a substantially rigid material that is waterproof and is mechanically relatively strong. For example, the medium 236 comprising a single layer may comprise vinyl, plastic, or a metal such as aluminum. The medium 236 preferably comprises a thickness of about ⅛″ or less, as an example.

In this embodiment, the portion 244 of the digital photographic image 252 is preferably printed directly onto the medium 236. This may be accomplished using a Durst Rho 160W or Durst Rho 205 manufactured by Durst Phototechnik in Brixen, Italy, for example. Alternatively, an Inca Eagle 44 UV Flatbed Inkjet Printer by Sericol Imaging, in Kansas City, Kans., may be used, as another example. Other rigid board printing equipment may alternatively be used.

These printers are adapted to recreate digital information onto rigid materials such as vinyls, plastics and metals. This embodiment, wherein the medium 236 comprises a single layer, is advantageous because few materials are required to manufacture the overhead door cover 230, (shown in FIG. 2). The medium 236 may comprise a self-adhesive substance disposed on the opposite side from the side the image portion 244 is printed on, in one embodiment. Alternatively, the medium 236 may be attached to an overhead garage door panel 106 using an attachment means 234, as shown in FIG. 3.

FIG. 4b shows an alternative embodiment of the present invention, wherein the panels 232 of the overhead door cover 230 (shown in FIG. 2) comprise two or more layers 240 and 242. For example, the portion 244 of the digital photographic image may be enlarged and recreated onto a first layer 240 which may comprise vinyl, as an example, although other materials may also be used. The first layer 240 is then adhered to a second layer 242, which may comprise a metal, for example. The first layer 240 may comprise a self-adhesive substance disposed on the opposite side from the side the image portion 244 is printed on, in one embodiment. Alternatively, the first layer 240 may be adhered to the second layer 242 using a roll-on or brush-on adhesive, or double-sided tape, or using other attachment means, as examples. The back surface of the second layer 242 may then be adhered to the front surface of an overhead door panel 106d, as demonstrated in FIG. 3. In one embodiment, an adhesive material is disposed over 100% of the area of the panels 232/106, for example. The first layer 240 and the second layer 242 may comprise vinyl, plastic, metal, a self-adhesive material, a water-proof material, or combinations thereof, as examples, although alternatively, the first layer 240 and the second layer 242 may also comprise other materials. The total thickness of the first layer 240 and the second layer 242 preferably is no greater than about ¼″, to prevent interference when an overhead door 100 is in the process of opening into a retracted position.

The panels 232 described with reference to FIGS. 4a and 4b may be attached to an overhead door panel 106 using a variety of attachment means. For example, the attachment means 234 shown in FIG. 3 may comprise an adhesive, a self-adhesive, double-sided tape, duct tape, screws, self-tapping screws, rivets, construction adhesive, caulking, nuts and bolts, a magnetic medium, or combinations thereof, although alternatively, the attachment means 234 may comprise other materials and fastening devices, for example. The attachment means 234 may comprise a roll-on or brush-on adhesive, for example. A sealant may be disposed between the edges of the panels 106 of the overhead door and the back surface of the panels 232, wherein the sealant preferably comprises caulk, silicon rubber, or a sealant strip, as examples.

FIG. 4c shows a cross-sectional view of an alternative embodiment of the present invention, wherein the portion 244 of the digital photographic image is enlarged and recreated directly onto the surface of the overhead door panel 270. Overhead door panels typically comprise metals such as steel. In this embodiment, preferably the overhead door panel 270 is substantially flat and planar, comprising no three-dimensional patterns or designs (such as design 118 and window 116a shown in FIG. 3). In one embodiment, the overhead door panel 270 may comprise a faux wood grain finish with mild variations in surface topography, although preferably the topography has no greater depth than about 1/64″ or less. These wood grains may be included in the overhead door panel 270 during the forming of the panel 270 in the fabrication process and will not affect the printing process when the portion 244 of the digital photographic image is printed directly onto the overhead door panel 270.

In this embodiment, preferably, the overhead door cover panel comprises the overhead door panel 270 itself. Therefore, in this embodiment, it is envisioned that a manufacturer of an overhead door would utilize the method of covering an overhead door with a realistic image of an object or scene, in accordance with embodiments of the present invention, in the fabrication process of the overhead door. Whereas, in the embodiments shown in FIGS. 4a and 4b, the overhead door cover panels 232 may be installed by consumers themselves, or alternatively, an overhead door service company may install the overhead door cover panels 232, as examples.

The portions 244 of the digital photographic image 252 are preferably formed on the medium 236, 240 (FIGS. 4a and 4b), or the overhead door panel 270 (FIG. 4c) using a colorized substance such as ink or paint, for example. Preferably, the portions 244 of the image 252 are printed onto the medium 236, 240 or overhead door panels 270 using photoengraving, photoprinting, photoscreening, or digital printing, as examples.

Preferably, a primer comprising a colored coating is applied to the medium 236, 240 or overhead door panels 270 before forming the portions 244 of the digital photographic image 252 on the medium 236, 240 or the overhead door panel 270. The primer may comprise a light-colored coating in one embodiment. The medium 236, 240 or overhead door panel 270 may already have the primer applied, or a separate application of a primer may be required. For example, overhead door panels 270 typically have a white, almond or other light colored coating applied at the factory. The portions 244 of the digital photographic image 252 may be applied directly to the pre-primed surface of the overhead door panels 270, in this case.

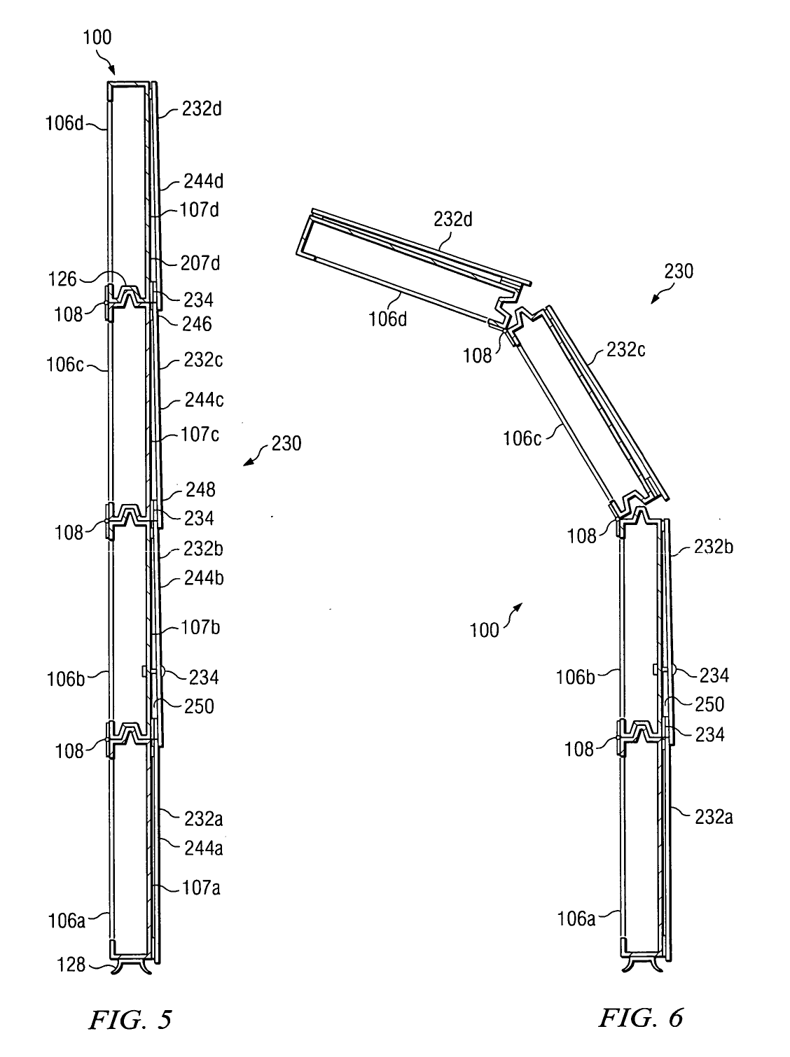

FIG. 5 shows a cross-sectional view of an overhead door 100 such as the one shown in FIG. I having an overhead door cover 230 installed thereon in accordance with an embodiment of the present invention. The overhead door 100 includes a plurality of panels such as the four panels 106a, 106b, 106c, and 106d shown. Each panel 106a, 106b, 106c, 106d includes a front surface 107a, 107b, 107c, 107d, respectively. The front surface 107a through 107d preferably faces the exterior of a dwelling, for example. The overhead door 100 includes hinges 108 between each panel 106a and 106b, 106b and 106c, and 106c and 106d, as shown. In some overhead door 100 designs, the panels 106d, 106c and 106b include grooves 126 at their interface in order to prevent water and debris from entering the dwelling. A seal 128 is commonly attached to the bottom panel 106a, to prevent water from entering the dwelling upon which the overhead door 100 is installed.

The overhead door cover 230 comprises a plurality of panels, e.g., four panels 232a, 232b, 232c, 232d which correspond to and are attached to panels 106a, 106b, 106c, and 106d of the overhead door 100, respectively. Each panel 232a, 232b, 232c, 232d comprises a portion 244a, 244b, 244c, 244d of a digital photographic image (such as image 252 shown in FIG. 2), respectively. The digital photographic image 252 preferably comprises digital information which may be manipulated and altered using a computer, for example. The digital photographic image 252 is divided horizontally into quarters, with each one-quarter of the image 252 being a portion 244 of the digital photographic image 252. In this manner, a composite recreation of the digital photographic image 252 of FIG. 2 can be recreated and visualized by a viewer on the surfaces of the panels 232a, 232b, 232c, and 232d when installed on the panels 106a through 106d of the overhead door 100. As described earlier herein, the panels 232a through 232d of the overhead door cover 230 are preferably installed by one or more attachment means 234.

In one embodiment, the overhead door 100 comprises a first number of first horizontally-extending panels 106, wherein the digital photographic image portions 244 disposed on each first horizontally-extending panel 106 comprises a fraction of the digital photographic image 252 equal to about 1/the first number. For example, for an overhead door comprising four panels 106, the first number equals four, and the digital photographic image portion 244 disposed on each first horizontally-extending panel 106 comprises about ¼ of the digital photographic image 252.

In one embodiment, as shown in FIG. 5, adjacent panels 232 overlap one another, to prevent water and debris from entering the dwelling. For example, panel 232c of the overhead door cover 230 overlaps a top portion of panel 232b. This may be accomplished, for example, by using a thinner piece of adhesive tape at the upper region 246 of panel 232c than at a lower region 248 of 232c. The overlap of adjacent panels 232 may be achieved using other methods and techniques, alternatively.

FIG. 6 shows the embodiment shown in FIG. 5, wherein the overhead door 100 is in the process of being retracted. Preferably, each panel 232a, 232b, 232c, 232d moves fixedly with a panel 106a, 106b, 106c, 106d, respectively, as the overhead door 100 is opened and closed.

Note that there may be an air space 250 disposed between the panels 232a through 232d of the overhead door cover 230 and the panels 106a through 106d of the overhead door 100, respectively. This is advantageous because the air space 250 provides improved insulation for the room on which the overhead door 100 is attached.

Embodiments of the present invention may also be applied to overhead doors having a single panel. The plurality of panels 232 of the overhead door cover 230 are attached directly to the single panel overhead door (not shown). Each panel 232 preferably directly abuts, or alternatively, slightly overlaps, an adjacent panel 232, so that the digital photographic image 252 appears realistic when viewed on the single panel overhead door.

Preferably, the overhead door covers 230 described herein are attached permanently rather than temporarily to existing overhead doors. For example, the overhead door covers 230 are preferably installed and are left in place for a number of years, or for the life of the home. However, in one embodiment, the overhead door cover 230 may be removable so that it may be replaced, e.g., if the overhead door cover 230 becomes worn or faded, or if a different image 252 is desired. The images 252 described herein are preferably not celebrative of a particular season, but rather, depict realistic images that are intended to remain on the overhead door for many years.

In one embodiment, the digital photograph may be modified using a computer, for example, before recreating portions 244 of the digital photographic image 252 onto a medium 236 or 238 or directly onto an overhead door panel 270. For example, a digital photograph may be taken of a desired object or scene, and the digital photograph may be enhanced to create shadows or improve the image 252 before dividing the image 252 into portions 244 and then recreating the portions 244 of the image onto the medium 236 or 238 or overhead door panel 270.

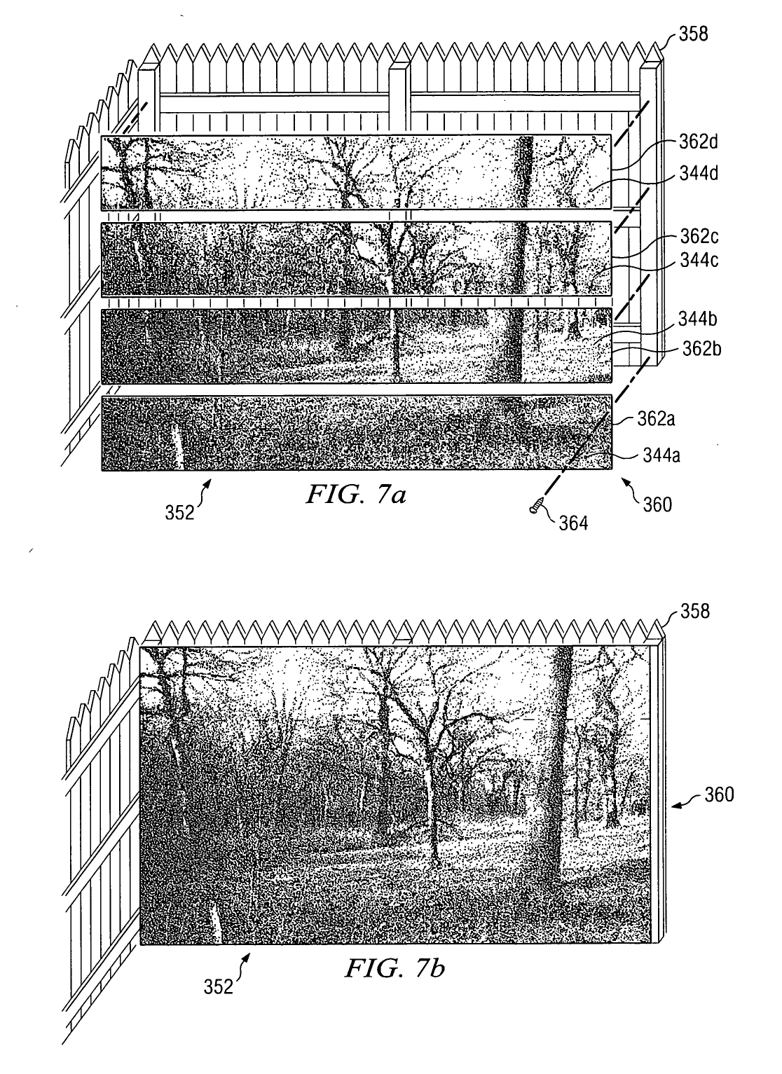

Embodiments of the present invention comprising a plurality of panels 362a through 362d may be used in other applications such as to cover fences 358, as shown in FIGS. 7a and 7b. An owner of a home or business may find that they would like an improved view rather than merely looking at a wooden fence 358 or other type of vertical, relatively flat structure. The overhead door cover 360 described herein may be used to cover such vertical surfaces, as shown in FIGS. 7a and 7b. In this embodiment, the panels 362a through 362d may comprise vinyl, plastic, metal, a self-adhesive material, a water-proof material, or combinations thereof, and alternatively, the panels 362a through 362d may comprise a vinyl cloth, for example. Each horizontally-extending panel 362a through 362d includes a portion 344a through 344d, respectively, of a digital photographic image 352 formed thereon. The panels 362a through 362d may be attached to a fence 358 using screws, nuts and bolts, or other fastening devices 364, as examples, although other fastening devices may alternatively be used, that optionally may be coated to prevent corrosion. The panels 362a through 362d may include a metal grommet to prevent tearing of the panels 362a through 362d, for example, during a strong windstorm. The fence cover 360 as shown in FIG. 7b provides a realistic image 352 of a nature scene, providing the illusion that the user's backyard is significantly larger than it actually is, as an example. The realistic image 352 of the nature scene may include garden flora, a trellis, panoramic views of fields, trees, hedgerows, hills, farms, garden scene, country scene, sky, clouds, a golf course scene, or combinations thereof, as examples.

Advantages of embodiments of the invention include providing increased security for an overhead door, and improved insulation, as well as an improved aesthetic appearance. The overhead door covers described herein may be waterproof, and may provide increased longevity of an overhead door by providing improved resistance to corrosion and fading of existing overhead door finishes caused by sunlight and exposure to the elements. Imperfections in overhead garage doors may be camouflaged or hidden beneath the overhead garage door covers described herein. In one embodiment, an aesthetically pleasing image of a wooden door or nature scene may be printed directly onto a panel of an overhead door, creating a realistic image of a wooden door or nature scene. The overhead door covers described herein are lightweight and provide an improved appearance of an overhead door at a minimal cost. The overhead door covers may be installed by homeowners themselves, or may alternatively be installed by an overhead door service company. In one embodiment, the overhead door cover panels overlap one another to provide increased waterproofing of the overhead door. The overhead door cover may also be used to cover substantially flat surfaces, such as a fence, or a single-panel garage door, as examples. The improved aesthetic appearance of the overhead door may also enhance property values. The overhead door covers described herein may also be used to cover retractable overhead doors such as loading dock doors, conference room dividers, truck rear doors, store front doors, and other overhead doors comprising one or more horizontally-extending panels, as examples.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An overhead door, the overhead door comprising:
a plurality of first horizontally-extending panels, each first horizontally-extending panel including a portion of a digital photographic image disposed thereon; and
a plurality of hinges coupling together the first horizontally-extending panels, wherein the digital photographic image portions disposed on the plurality of first horizontally-extending panels gives the overhead door the appearance of a realistic object or scene.

2. The overhead door according to claim 1, wherein the digital photographic image comprises an image of a wooden door, an old-fashioned-style wooden coach door, a set of wooden doors, a set of old-fashioned-style wooden coach doors, or a nature scene.

3. The overhead door according to claim 1, wherein the overhead door comprises a first number of first horizontally-extending panels, wherein the digital photographic image portions disposed on each first horizontally-extending panel comprises a fraction of the digital photographic image equal to about (1/the first number).

4. The overhead door according to claim 3, wherein the first number equals four, wherein the digital photographic image portion disposed on each first horizontally-extending panel comprises about ¼ of the digital photographic image.

5. The overhead door according to claim 4, wherein each portion of the digital photograph image is directly printed onto each first horizontally-extending panel.

6. The overhead door according to claim 5, further comprising a colored coating disposed on each first horizontally-extending panel, wherein each portion of the digital photograph image is printed onto the colored coating of each first horizontally-extending panel.

7. The overhead door according to claim 1, wherein each first horizontally-extending panel comprises a first height and a first width, wherein each portion of the digital photograph image is printed onto a second panel of a medium, each second panel having a second height and a second width, the second width being substantially equal to the first width, the second height being substantially equal to the first height, and wherein each second panel is attached to one of the first horizontally-extending panels of the overhead door.

8. The overhead door according to claim 7, wherein the medium comprises vinyl, plastic, metal, a self-adhesive material, a waterproof material, or combinations thereof, and wherein each second panel is attached to one of the first horizontally-extending panels of the overhead door using adhesive, self-adhesive, double-sided tape, duct tape, screws, self-tapping screws, rivets, construction adhesive, caulking, nuts and bolts, a magnetic medium, or combinations thereof.

9. A cover for an overhead door, the overhead door comprising at least one first horizontally-extending panel, the cover comprising:
a plurality of second panels, each of the second panels comprising a medium and having a portion of a digital photographic image disposed thereon, wherein each second panel is attached to the at least one first horizontally-extending panel, and wherein the digital photographic image portions disposed on the plurality of second panels gives the overhead door the appearance of a realistic object or scene.

10. The cover according to claim 9, wherein the digital photographic image comprises an image of a wooden door, an old-fashioned-style wooden coach door, a set of wooden doors, a set of old-fashioned-style wooden coach doors, or a nature scene.

11. The cover according to claim 9, wherein the overhead door comprises a first number of first horizontally-extending panels coupled together by hinges, wherein the first horizontally-extending panels are adapted to slide along a channel with the overhead door is opened and closed, wherein each first horizontally-extending panel comprises a first height and a first width, wherein each second panel comprises a second height and a second width, the second width being substantially equal to the first width, the second height being substantially equal to the first height, wherein the digital photographic image portion disposed on each second panel comprises a fraction of the digital photographic image equal to about (1/the first number), and wherein each second panel moves fixedly with a first horizontally-extending panel as the overhead door is opened and closed.

12. The cover according to claim 11, wherein the first number equals four, wherein the digital photographic image portion disposed on each second panel comprises about ¼ of the digital photographic image.

13. The cover according to claim 11, wherein at least one of the second panels is slightly oversized, the oversized second panel having a second height being about ⅛″ to ½″ greater than the first height of the first horizontally-extending panels, so that each oversized second panel overlaps an adjacent first horizontally-extending panel.

14. The cover according to claim 9, wherein the medium comprises vinyl, plastic, metal, a self-adhesive material, a water-proof material, or combinations thereof, and wherein the portion of the digital photographic image is printed directly on each of the second panels.

15. The cover according to claim 14, further comprising a colored coating disposed on each second panel, wherein each portion of the digital photograph image is printed onto the colored coating of each second panel.

16. The cover according to claim 9, wherein each second panel is attached to one of the first horizontally-extending panels of the overhead door using adhesive, self-adhesive, double-sided tape, duct tape, screws, self-tapping screws, rivets, construction adhesive, caulking, nuts and bolts, a magnetic medium, or combinations thereof.

17. The cover according to claim 9, wherein the overhead door comprises a single first horizontally-extending panel comprising a first height and a first width, wherein each second panel comprises a second height and a second width, the second width being substantially equal to the first width, the total of the second heights of the second panels being substantially equal to the first height of the single first horizontally-extending panel, wherein the digital photographic image portions are disposed on a first number of second panels, wherein the digital photographic image disposed on each second panel comprises a fraction of the digital photographic image equal to about (1/the first number).

18. The cover according to claim 9, wherein the at least one first horizontally-extending panel of the overhead door comprises at least one window, wherein the medium comprises an opaque material and covers the at least one window.

19. A method of covering an overhead door, the overhead door comprising at least one horizontally-extending panel, the method comprising:
providing a digital photograph of a scene or object, the digital photograph comprising digital information of an image of the scene or object; and
enlarging and recreating portions of the digital photograph onto the at least one horizontally-extending panel of the overhead door, wherein recreating the portions of the digital photograph on the at least one horizontally-extending panel of the overhead door gives the overhead door the appearance of a realistic object or scene.

20. The method according to claim 19, wherein enlarging the recreating the portions of the digital photograph onto the at least one horizontally-extending panel of the overhead door comprises printing the image directly onto the at least one horizontally-extending panel of the overhead door using photoengraving, photoprinting, photoscreening, or digital printing.

21. The method according to claim 19, further comprising modifying the digital information of the image, wherein recreating the portions of the digital photograph onto the at least one horizontally-extending panel of the overhead door comprises recreating a modified digital photograph of the scene or object.

22. The method according to claim 19, wherein providing the digital photograph comprises providing an image of a wooden door, an old-fashioned-style wooden coach door, a set of wooden doors, a set of old-fashioned-style wooden coach doors, or a nature scene.

23. The method according to claim 19, wherein the overhead door comprises a first number of horizontally-extending panels, further comprising:
dividing the digital photograph into a second number of sections, the sections being oriented horizontally.

24. The method according to claim 23, wherein the first number is equal to the second number, wherein the digital photographic recreated on each second panel comprises a fraction of the digital photographic equal to about (1/the first number).

25. The method according to claim 23, wherein the first number is equal to one, wherein the second number is two or greater.

26. The method according to claim 19, wherein enlarging and recreating the portions of the digital photograph onto the at least one horizontally-extending panel of the overhead door comprises:
providing a plurality of second panels, each of the second panels comprising a medium;
disposing the portions of the digital photographic image onto each second panel; and
attaching each second panel to the at least one first horizontally-extending panel.

27. The method according to claim 26, wherein the overhead door comprises a first number of first horizontally-extending panels coupled together by hinges, wherein the first horizontally-extending panels are adapted to slide along a channel with the overhead door is opened and closed, wherein each first horizontally-extending panel comprises a first height and a first width, wherein each second panel comprises a second height and a second width, the second width being substantially equal to the first width, the second height being substantially equal to the first height, wherein the portion of the digital photographic image disposed on each second panel comprises a fraction of the digital photographic image equal to about (1/the first number), and wherein each second panel moves fixedly with a first horizontally-extending panel as the overhead door is opened and closed.

28. The method according to claim 27, wherein the first number equals four, wherein disposing a portion of the digital photographic image onto each second panel comprises disposing about ¼ of the digital photographic image onto each second panel.

29. The method according to claim 27, wherein at least one of the second panels is slightly oversized, the oversized second panels having a second height about ⅛″ to ½″ greater than the first height of the first horizontally-extending panels, so that each of the oversized second panel overlaps an adjacent first horizontally-extending panel.

30. The method according to claim 26, wherein providing a plurality of second panels comprises providing a plurality of second panels comprising a medium comprising vinyl, plastic, metal, a self-adhesive material, a water-proof material, or combinations thereof.

31. The method according to claim 26, wherein attaching each second panel to the at least one first horizontally-extending panel comprises using adhesive, self-adhesive, double-sided tape, duct tape, screws, rivets, construction adhesive, caulking, nuts and bolts, a magnetic medium, or combinations thereof.

32. The method according to claim 26, wherein the overhead door comprises a single first horizontally-extending panel comprising a first height and a first width, wherein providing the plurality of second panels comprises providing a plurality of second panels each having a second height and a second width, the second width being substantially equal to the first width, the total of the second heights of the second panels being substantially equal to the first height of the single first horizontally-extending panel, wherein disposing the portion of the digital photographic image onto each second panel comprises disposing the digital photographic image portion on a first number of second panels, wherein disposing the portion of the digital photographic image onto each second panel comprises disposing a fraction of the digital photographic image equal to about (1/the first number).

33. A cover for a fence, the cover comprising:
a plurality of horizontally-extending panels, each of the horizontally-extending panels comprising a medium and having a portion of a digital photographic image disposed thereon, wherein each horizontally-extending panel is attachable to the fence, and wherein the digital photographic image disposed on the plurality of horizontally-extending panels gives the fence the appearance of a realistic nature scene.

34. The cover according to claim 33, wherein the medium comprises vinyl, plastic, metal, a self-adhesive material, a water-proof material, or combinations thereof, and wherein the portion of the digital photographic image is printed directly on each of the horizontally-extending panels.

35. The cover according to claim 33, wherein each second horizontally-extending panel is attached to the fence using screws, construction adhesive, nuts and bolts, or combinations thereof.

36. A method of covering a fence, the method comprising:
providing a digital photograph of a nature scene, the digital photograph comprising digital information of an image of the nature scene
dividing the digital photograph into sections, the sections being oriented horizontally;
providing a plurality of horizontally-extending panels, the horizontally-extending panels comprising a medium;
enlarging and recreating each section of the digital photograph onto the plurality of horizontally-extending panels; and
attaching the plurality of horizontally-extending panels to the fence, wherein the plurality of horizontally-extending panels gives the fence the appearance of a realistic nature scene.

37. The method according to claim 36, wherein enlarging and recreating the digital photograph onto the plurality of horizontally-extending panels comprises printing the image directly onto the at least one panel of the medium using photoengraving, photoprinting, photoscreening, or digital printing.

38. The method according to claim 36, wherein providing the plurality of horizontally-extending panels comprises providing a plurality of panels comprising a medium comprising vinyl, plastic, metal, a self-adhesive material, a water-proof material, or combinations thereof, and wherein attaching the plurality of horizontally-extending panels to the fence comprises using screws, construction adhesive, nuts and bolts, or combinations thereof.
